(19) United States
(12) Patent Application Publication
(10) Pub. No.: US 2004/0210790 A1
(43) Pub. Date: Oct. 21, 2004

(54) 0.6-2.5 GBaud CMOS tracked 3X oversampling transceiver with dead zone phase detection for robust clock/data recovery

(76) Inventors: Yongsam Moon, Cupertino, CA (US); Deog-Kyoon Jeong, Seoul (KR); Gijung Ahn, Sunnyvale, CA (US)

Correspondence Address: PERKINS COIE LLP, P.O. BOX 2168, MENLO PARK, CA, 94026, US

(21) Appl. No.: 10/305,254

(22) Filed: Nov. 25, 2002

Related U.S. Application Data
(60) Provisional application No. 60/333,439, filed on Nov. 26, 2001.

(51) Int. Cl. G06F 1/04; G06F 1/06

(52) U.S. Cl. 713/500

(57) ABSTRACT

For generation of the multiphase clocks for a serializer, a wide-range multiphase delay-locked loop (DLL) is used in the transmitter to avoid the detrimental characteristics of a phase-locked loop (PLL), such as jitter peaking and accumulated phase error. A tracked 3× oversampling technique with dead-zone phase detection is incorporated in the receiver for robust clock/data recovery in the presence of excessive jitter and inter-symbol interference (ISI). Due to the dead-zone phase detection, phase adjustment is performed only on the tail portions of the transition histogram in the received data eye, thereby exhibiting wide pumping-current range, large jitter tolerance, and small phase error. A voltage-controlled oscillator (VCO), based on a folded starved inverter, shows about 50% less jitter than one with replica bias. The transceiver, implemented in 0.25 μm CMOS technology, operates at 2.5 GBaud over a 10-m 150-Ω STP cable and at 1.25 GBaud over a 25-m cable with a bit error rate (BER) of less than 10⁻¹³.

### CROSS REFERENCE TO RELATED APPLICATIONS

The present application is related to and claims benefit from co-pending provisional application “A 0.6-2.5 Gbaud CMOS Tracked 3× Oversampling Transceiver with Dead Zone Phase Detection for Robust Clock/Data Recovery” by Inventors Yongsam Moon, Deog-Kyoon Jeong and Gijung Ahn (Ser. No. 60/333,439, filed on Nov. 26, 2001, attorney docket # 59472-8079.US00) and incorporated herein by reference.

### FIELD OF THE INVENTION

The present invention relates to the field of data communications. In particular the present invention discloses methods and circuits for robust data recovery on a high-speed serial data link.

### BACKGROUND OF THE INVENTION

Considerable research effort has focused on implementing the physical layers of Gigabit Ethernet, Fibre Channel, IEEE1394, network switch, etc. The major goal is to give the physical layer a high bandwidth transmission for digital data over a long cable with a low bit error rate (BER). As more transceivers operate at higher frequencies and over longer cables, the signal frequencies tend to come close to the channel bandwidth. Bandwidth limitation in the channel causes signal degradation, in the form of inter-symbol interference (ISI), as shown in FIG. 1. Signal degradation shows up in the eye diagram as eye-closure: the center of the eye is smaller in both time and signal amplitude. Eye-closure causes higher BER since it restricts successful data-detection to a smaller time interval.

According to IEEE std 802.3z, Gigabit Ethernet standard, the receiver shall operate if the total jitter of data transition is less than 71% of the bit time, where deterministic jitter takes up 45% and random jitter, 26%. Deterministic jitter is also referred to as systematic jitter and is caused mostly by ISI and duty-cycle distortion. Random jitter is also referred to as nonsystematic jitter and is generated by a number of noise sources such as thermal noise, power supply noise, substrate noise, etc. Random jitter is Gaussian in nature, while deterministic jitter is due to non-Gaussian events as shown in FIG. 1(b).

Random jitter is generated in both the transmitter and receiver. A transmitter clock is generated by a transmitter-side PLL or DLL. Since this clock switches the serializer, the outgoing data stream inherits the jitter component of the PLL- or DLL-generated clock. The receiver clock samples the data with its own jitter component. Thus, the equivalent jitter is the sum of both jitter components. As the transceiver operates at higher frequencies and the bit time becomes shorter, the random jitter will occupy a greater portion of the bit time and then the eye opening will narrow. Therefore, for a lower BER, jitter should be reduced in both the transmitter and receiver as the frequency increases.

In general, a clock recovery circuit takes a sequence of times at which a transition edge of a pulse crosses some threshold voltage and averages the times to extract the real input pulse timing. This averaging process makes the clock recovery circuit tolerant to input jitter. Jitter tolerance is a very critical requirement for clock recovery circuits. With the same circuit and process the jitter tolerance will be dependent on the transceiver architecture.

Currently, many transceivers are designed to be a macro-cell of an ASIC standard cell library as well as a stand-alone component. Thus, both small area and low power consumption become essential in the transceiver design. In order to measure the BER of a transceiver in an operating frequency, a test board with a small number of field programmable gate array (FPGA) chips is required. The FPGA in the transmitter side generates an appropriate bit sequence, and that in the receiver monitors the sequence and measures the BER. If built-in self-test (BIST) capability is included on chip, this will take the place of the FPGAs. The BIST can lower the test cost and cover the entire frequency range of the transceiver. As mentioned above, when designing a high-speed transceiver with a low BER, jitter reduction and jitter tolerance of the architecture are the most important design issues. Low power consumption, small chip area, and testability are also design concerns.

### SUMMARY OF THE INVENTION

An apparatus, in accordance with an embodiment of the present invention, includes means for generating a data sampling clock signal and means for using the data sampling clock signal to sample a data signal into sampled data representing a first zone, a second zone, and a third zone of the data signal. Means are used for determining which zone of the sampled data has a transition of the data signal. Means are also used for indicating a direction of change for the data sampling clock signal if the first zone or the third zone has the transition.

A folded starved inverter differential output apparatus for use in a voltage controlled oscillator, in accordance with another embodiment of the present invention, includes a first polarity of two transistors cross-coupled and a second polarity of four transistors. Also included are two inverter gates and a supply regulator.

A frequency comparator apparatus used with a reference clock, a voltage controlled oscillator circuit and a phase locked loop circuit, in accordance with a final embodiment of the present invention, includes a reference loop circuit; wherein the reference loop circuit is activated when the frequency difference between the reference clock and the voltage controlled oscillator circuit is greater than 1000 parts per million. Also included is a data loop circuit; wherein the data loop circuit is activated when the frequency difference between the reference clock and the voltage controlled oscillator circuit is less than 200 parts per million.

These and other advantages of the present invention will become apparent to those skilled in the art upon a reading of the following detailed descriptions and a study of the various figures.

### BRIEF DESCRIPTION OF THE DRAWINGS

FIGS. 1A and 1B are prior art eye diagrams of serial data before and after transmission over a cable link.

FIG. 2 is a schematic diagram of a transmitter architecture, in accordance with the prior art.

FIG. 3A is a block diagram of a prior art wide-range multiphase delay locked loop.

FIG. 3B is a block diagram of a wide-range multiphase delay locked loop, in accordance with the present invention.

FIG. 4A is a block diagram of a coarse phase detector, in accordance with the present invention.

FIG. 4B is a block diagram of a skewed current phase detector, in accordance with the present invention.

FIG. 4C is a timing diagram of the skewed current phase detector, in accordance with the present invention.

FIG. 5 is a block diagram of a wide range multiphase DLL, in accordance with the present invention.

FIG. 6 is a block diagram of a receiver architecture, in accordance with the present invention.

FIG. 7A is an eye diagram of a prior art tracked 2× oversampling receiver.

FIG. 7B is an eye diagram of a tracked 3× oversampling receiver, in accordance with the present invention.

FIGS. 8A and 8B are an analysis of bit error rate for three different phase detection types.

FIGS. 9A and 9B are a comparison pumping current range between 2× and 3× oversampling receivers.

FIG. 10A is a prior art asymmetric jitter histogram of a 2× oversampling receiver.

FIG. 10B is an asymmetric jitter histogram of a 3× oversampling receiver, in accordance with the present invention.

FIG. 11A is a prior art timing diagram of a 2× oversampling receiver in an ISI environment.

FIG. 11B is a timing diagram of a 3× oversampling receiver in an ISI environment, in accordance with the present invention.

FIG. 12A is a graph of accumulated phase errors for a 3× oversampling receiver with 20 microamperes of pumping current, in accordance with the present invention.

FIG. 12B is a prior art graph of accumulated phase errors for a 2× oversampling receiver with 20 microamperes of pumping current.

FIG. 12C is a graph of accumulated phase errors for a 3× oversampling receiver with 60 microamperes of pumping current, in accordance with the present invention.

FIG. 13 is a block diagram if a frequency comparator with hysteresis, in accordance with the present invention.

FIG. 14 is a block diagram of a voltage controlled oscillator, in accordance with the persent invention.

FIG. 15 is an example layout of various aspects of the present invention.

FIG. 16A is a jitter histogram of a DLL clock, in accordance with the present invention.

FIG. 16B is a jitter histogram of a PLL clock, in accordance with the present invention.

FIG. 17A is an eye diagram of serial data before a 25-meter cable link.

FIG. 17B is an eye diagram of serial data after a 25-meter cable link, utilizing the present invention.

FIG. 17C is a jitter histogram of recovered clock data, in accordance with the present invention.

FIG. 18A is an eye diagram of serial data before a 10-meter cable link.

FIG. 18B is an eye diagram of serial data after a 10-meter cable link, utilizing the present invention.

FIG. 18C is a jitter histogram of recovered clock data, in accordance with the present invention.

### DETAILED DESCRIPTION OF THE PREFERRED EMBODIMENT(S)

### Transmitter Architecture

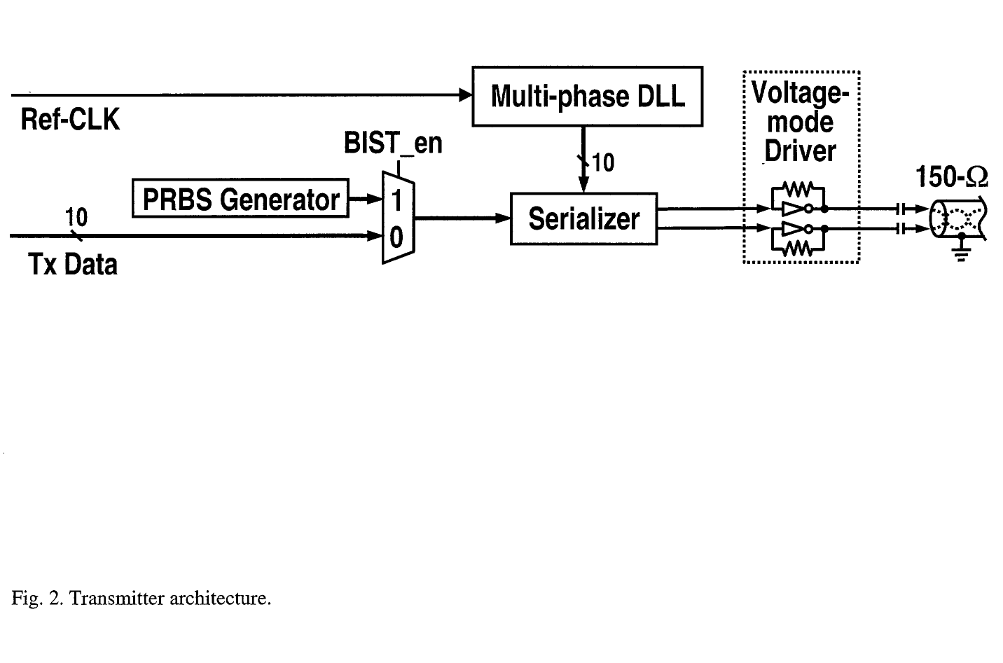

The proposed transmitter incorporates a voltage-mode driver, a serializer, an analog multiphase delay-locked loop (DLL), and a pseudo-random binary sequence (PRBS) generator for BIST as shown in FIG. 2. Unlike a conventional current-mode driver, where only pull-down current is provided, the voltage-mode driver offers both active pull-up and pull-down, which makes it possible to maintain its high speed in the presence of parasitic capacitance associated with bonding pads and ESD protection diodes, regardless of cable impedance. Furthermore, the driver can be AC-coupled to a cable without additional load resistors. When the BIST is enabled, the PRBS generator provides DC-balanced 10-bit data at every reference clock cycle with a maximum run length of 6. A special character is periodically inserted for the synchronization with a remote receiver.

In the transmitter section, multiphase clocks are required to drive the serializer. In conventional transceivers where two PLLs are used, one in each of the transmitter and receiver, if both PLL bandwidths were identical, jitter peaking at the bandwidth would grow, rather than be suppressed. Since the transmitter requires only multiphase clock generation, but neither clock recovery nor frequency synthesis, a DLL can be used rather than a PLL. A DLL has a flat jitter transfer function and the aforementioned jitter peaking problem can be avoided. In addition, a DLL is typically smaller and requires less power than the equivalent PLL.

A. Wide-Range Multiphase Delay-Locked Loop

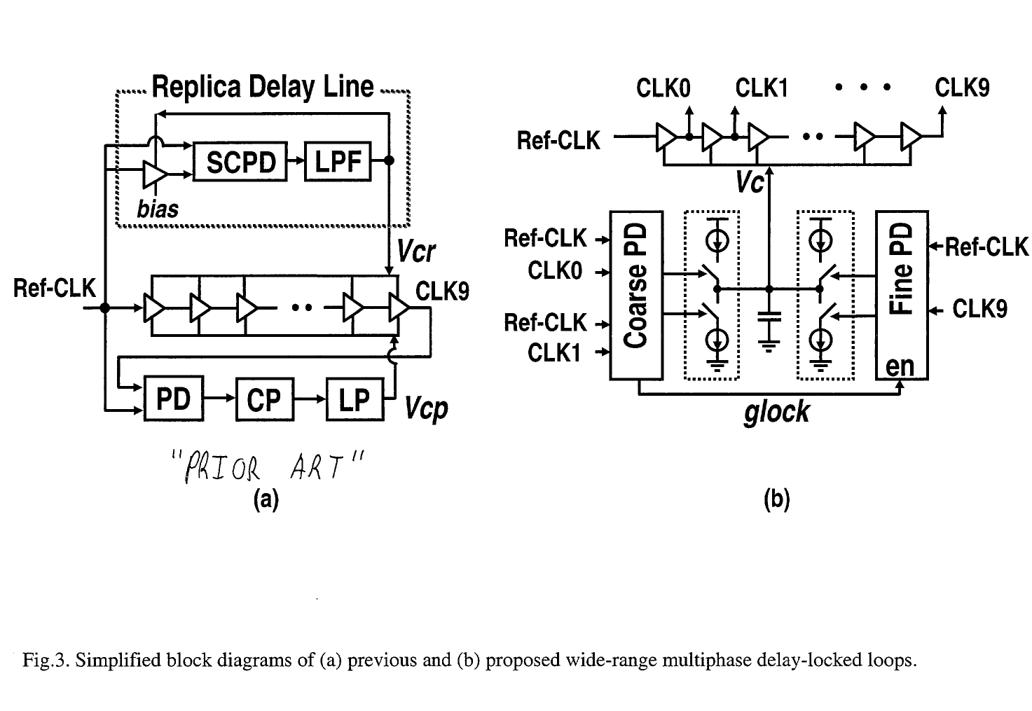

Since a conventional DLL adjusts only phase, not frequency, the operating frequency range is severely limited and the DLL is prone to stick or lock to an undesired delay time, which is called as stuck and harmonic lock problems and analyzed in in detail. Thus, when designing a wide-range multiphase DLL, careful consideration is required to avoid these problems. While other wide-range DLLs use phase mixers or phase selections to generate a single clock output, the DLL in uses a multistage voltage-controlled delay line (VCDL) similar to those used by conventional DLLs. Therefore, the DLL can generate multiphase clocks without using an excessive amount of hardware. In, delay cells are controlled by two lines as shown in FIG. 3(a). A replica delay line generates a control voltage, Vcr, to prevent false locking to harmonics and sets the delay range of the delay cells. However, since the delay range is limited by a bias voltage, bias, the DLL exhibits only a 4× operating range. A new DLL architecture is proposed to increase the operating range.

A VCDL, consisting of ten delay cells, generates ten clock outputs, as shown in FIG. 3(b). It uses one merged control voltage, Vc. In general, the initial delay time of a VCDL could be out of lock range. Therefore, at first, a coarse phase detector forces the delay time towards the lock range. The coarse phase detector takes a reference clock (Ref-CLK), CLK0, and CLK1 as the inputs, but not CLK9. After the delay time is placed within the lock range, the control is transferred from the coarse phase detector to a fine phase detector. At this time, the signal glock activates the fine phase detector. Then, the fine phase detector removes the residual phase error between Ref-CLK and CLK9.

For the fine phase detector not to fall prey to the stuck problem, the delay time of the VCDL, T_{VCDL} should satisfy the following inequality:

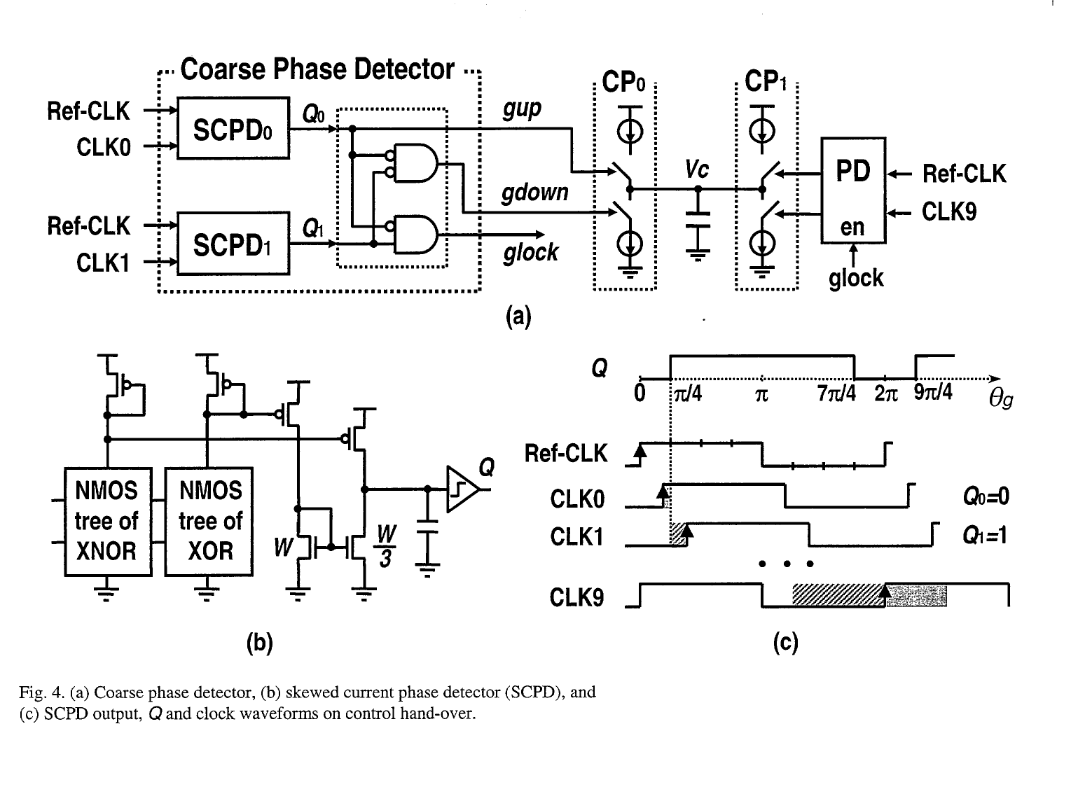

0.5×T_{CLK}<T_{VCDL}<1.5×T_{CLK}, (1)

where T_{CLK} is the period of the reference clock. However, the range of T_{VCDL}, is generally wider than this constraint and the initial value of T_{VCDL} is not known at start-up. To place the initial T_{VCDL} within this range (1), the coarse phase detector, consisting of two skewed-current phase detectors (SCPDs), is used as shown in FIG. 4(a). The SCPD is an exclusive-OR gate with high precision. However, since the upper to lower current ratio is tuned to 3:1 as shown in FIG. 4(b), its output Q has a high-to-low duration ratio of 3:1 as shown in FIG. 4(c), where θ_{g}, denotes the delay, or phase difference, between the two inputs of the SCPD, and a phase difference of 2π corresponds to T_{CLK}. If the Ref-CLK-to-CLK0 delay, that is the delay time (T_{DC}) of one delay cell, is between ⅛×T_{CLK} and ⅞×T_{CLK}, the SCPD₀ output Q₀, will be high, thereby activating the gup signal and disabling the gdown and glock signals. Then, gup increases Vc until T_{DC} is reduced to less than ⅛×T_{CLK}. Conversely, if the Ref-CLK-to-CLK1 delay time, 2×T_{DC}, is less than ⅛×T_{CLK}, the SCPD₁ output Q₁ will be low, thereby activating the gdown signal. Then, Vc decreases until 2×T_{DC} is larger than ⅛×T_{CLK}. Once coarsely phase-locked, Ref-CLK, CLK0, and CLK1 maintain the delay relationship shown in FIG. 4(c). This can be summarized by the following inequality:

T_{DC}<⅛×T_{CLK}, 2×T_{DC}>⅛×T_{CLK} (2)

or equivalently in terms of T_{VCDL}:

⅝×T_{CLK}<T_{VCDL}<5/4×T_{CLK}, (for T_{DC}=1/10×T_{VCDL}). (3)

In this locked state, Q₁ is ‘0’ and Q₂ is ‘1’. Therefore, gup and gdown are ‘0’ and glock is ‘1’. Then, CP₀ is disabled and the (fine) PD is activated. Since T_{VCDL} is the Ref-CLK-to-CLK9 delay time, the inequality (3) implies that the phase of CLK9 could vary as indicated by the shading in FIG. 4(c). However, since the inequality (3) satisfies the inequality (1) with some margin, the control hand-over is smooth without losing the lock. The PD later removes the residual phase error between Ref-CLK and CLK9.

As long as the following inequality (4) is satisfied, the coarse phase detector works correctly as explained above.

T_{DC.max} (=1/10×T_{VCDL.max})<⅞×T_{CLK}. (4)

Inequality (4) determines the lower bound of the DLL operating range as follows:

4/35×T_{VCDL.max}<T_{CLK}≦TVCDL.max. (5)

Hence, the DLL has a theoretical operating range of 8.75:1. Experimental results show that the prototype DLL works from 30 to 250 MHZ, an 8.3:1 operating range.

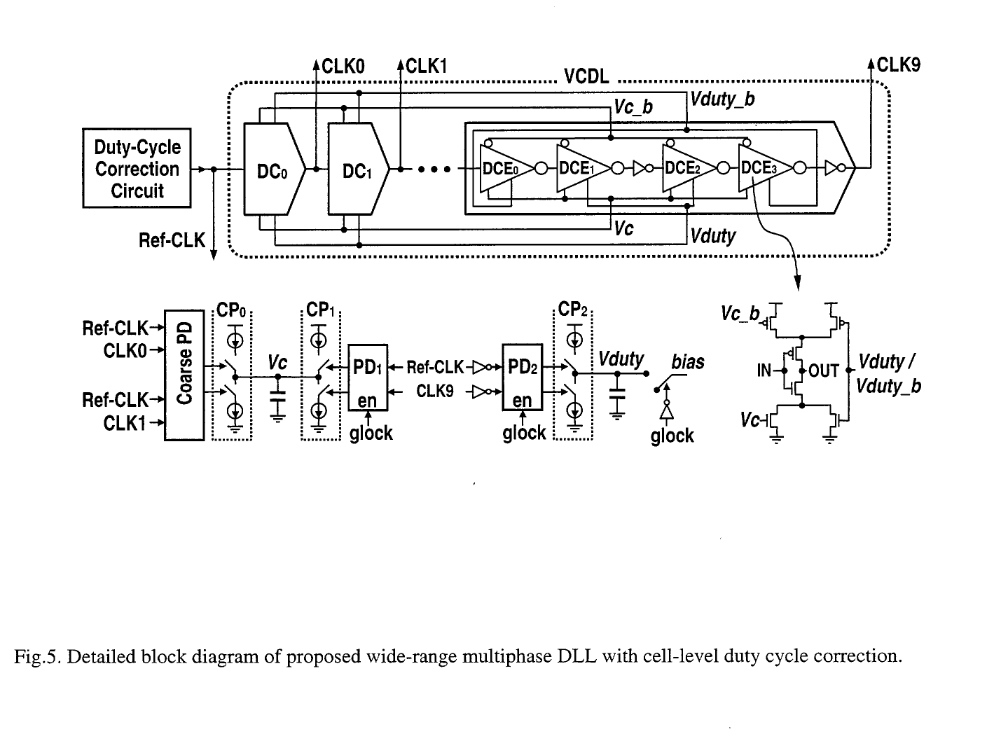

In high-speed operations, the clock output with a short cycle time can be severely distorted as the clock passes through many delay cells. Even if the duty cycle of Ref-CLK is 50% at the entrance, that of CLK9 may deviate significantly from 50%. This causes multiphase clock outputs to have a phase error, which could be fatal in high-speed operations. A cell-level duty cycle correction scheme has been adopted in this design as shown in FIG. 5. On the control hand-over, another phase detector, PD₂, is also activated and performs cell-level duty cycle correction. The PD₂ takes the inverted Ref-CLK and inverted CLK9 as the inputs, adjusting a control voltage, Vduty. Before the control hand-over, Vduty maintains such a bias voltage that it may generate the identical cell currents in the up and down paths of a delay cell element (DCE), as shown in FIG. 5. After the control hand-over, Vduty fine-tunes the current ratio of the DCE and thus aligns the falling edges of Ref-CLK and CLK9. A duty-cycle correction circuit (DCC) used right at the input of Ref-CLK corrects the duty cycle of Ref-CLK only. With cell-level duty cycle correction, all intermediate clock outputs as well as CLK9 maintain a 50% duty cycle. In this way, multiphase clocks are made equally spaced with a 50% duty cycle.

### Receiver Architecture

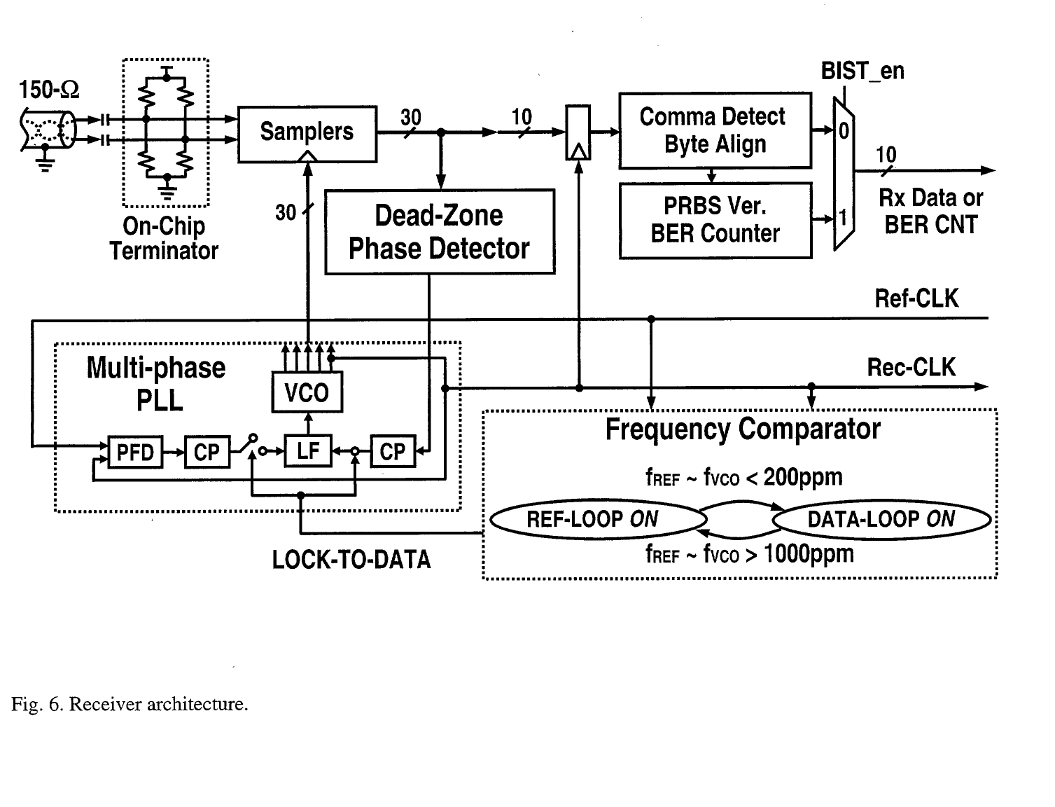

The proposed receiver is composed of an on-chip terminator [3], data samplers, a multiphase PLL and a tracked 3× oversampling circuit with dead-zone phase detection for timing recovery, a frequency comparator as a frequency acquisition aid, and a comma detection circuit, as shown in FIG. 6. The reference frequency is provided externally from a crystal and is expected to show a 100 ppm tolerance from its nominal value. Thus, the maximum frequency difference between the reference clock and the recovered clock is less than 200 ppm. The VCO frequency is driven toward the reference frequency with the aid of a phase frequency detector (PFD) in the PLL until reaching the lock range of the PLL. The frequency comparator activates a phase tracking operation only after the frequency lock is obtained when the external reference and VCO frequencies are within 200 ppm. In general, the capture range of a PLL is greater than the lock range. Hence, the frequency comparator is designed to have hysteresis that closely matches the capture and lock range of the PLL, whereas the frequency comparator in does not have hysteresis. The comma detection circuit monitors the incoming data stream to search for the K28.5 pattern in IBM 8B/10B coding for byte alignment. A built-in self-test (BIST) with PBRS generation, verification, and an error counting logic is integrated in the chip to simplify testing at full speed.

A. Tracked Oversampling Receiver

In clock and data recovery (CDR) systems with a tracked oversampling technique, multiple samples per bit are used to determine whether the phase of the recovered clock leads or lags the phase of the incoming data. The oversampling effectively behaves as the phase detector. If the VCO phase leads the incoming data, a DOWN pulse is set to HIGH. If the VCO phase lags, an UP pulse goes to HIGH. Each DOWN or UP pulse drives its dedicated charge pump, thereby discharging or charging a loop filter. Digital PLL-based oversampling receivers inherently have a static sampling phase error and suffer from an abrupt phase jump due to phase quantization, thereby sometimes showing an unacceptably high BER at higher data-rates. Alternately, in tracked oversampling receivers, the continual charge pumping removes the phase error gradually without an abrupt phase jump, thereby reducing the BER and, since CDR and data retiming are performed simultaneously, an additional data rotator or data selector is not required, Unlike a conventional non-oversampling CDR, the operating frequency of both the VCO and digital circuits are reduced to 1/10 the data rate and thus the design is relatively simple and robust.

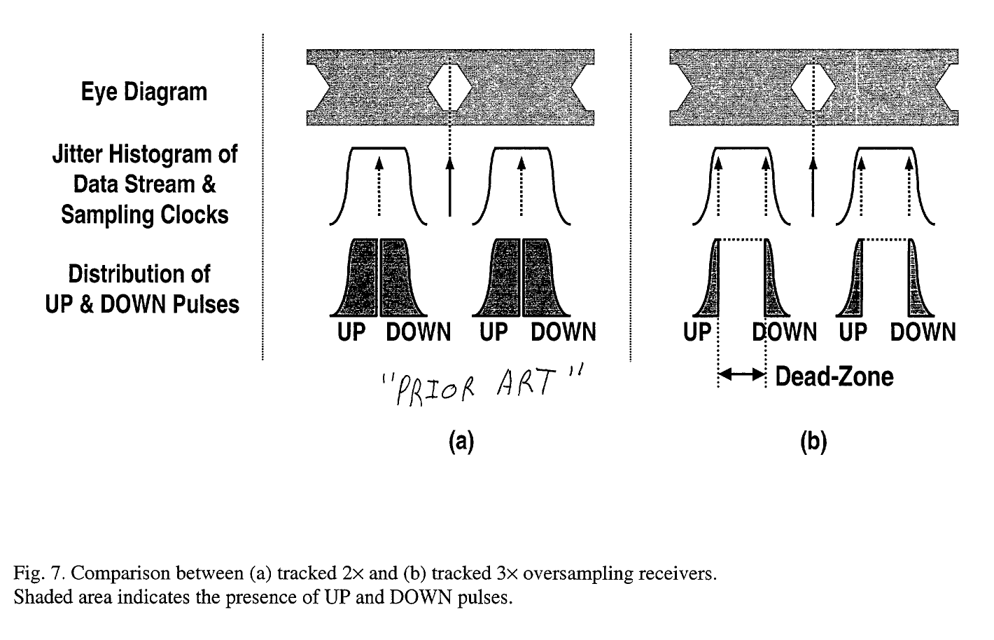

After the signal is sent over a long cable, the received data eye is severely degraded as shown in FIG. 7. Sampled bits are examined to determine whether to move the sampling clock phases earlier (UP) or later (DOWN). Sampling clock location is settled in steady state, where the number of UP pulses is equal to the number of DOWN pulses as shown in FIG. 7. In the tracked 2× oversampling technique, an UP or DOWN signal always pulses at every transition as shown in FIG. 7(a). Therefore, the average error current (id) over a bit time is

i_{d}=Iₚα·sgnθₑ, (6)

where Iₚ is the actual pumping current of a charge pump, α is transition density, and sgnθₑ is the sign of the phase error. However in this tracked 3× oversampling technique, only the tall portions of the histogram activate the phase adjustment, and the transition edges located in a dead-zone—the middle portion of one-third of the bit time—are ignored for phase comparison as shown in FIG. 7(b). Because of the existence of this dead-zone, the phase detection of the tracked 3× oversampling technique is referred to as dead-zone phase detection.

The jitter histogram of the data stream in FIG. 7 is based on a receiver specification. If the equivalent jitter histogram with a uniform probability density function (pdf) is used for the simplicity of calculation, the average error current of the dead-zone phase detection can be calculated as follows:

$${i}_{d} = {I}_{p} \cdot α \cdot \frac{{T}_{j} - 1 / 3}{{T}_{j}} \cdot sgn {θ}_{e} , \qquad ( 7 )$$

where T_{J} is the equivalent total jitter amount and ‘T_{J}−⅓’ is the amount of jitter activating the phase adjustment. Equation (7) indicates the average error current is related to T_{J}. If T_{J} is 50% of the bit time, i.e., 0.5× unit interval (UI), the average error current becomes

$${i}_{d} = {I}_{p} \cdot α \cdot \frac{1}{3} \cdot sgn {θ}_{e} , \qquad ( 8 )$$

The dead-zone phase detection has one-third the average error current of the 2× oversampling technique. In other words, for the same average error current, the dead-zone phase detection can use a pumping current that is three times larger than the 2× oversampling.

B. Wide Pumping Current Range of Dead-Zone Phase Detection

To guarantee the stability of a PLL, the following stability limit should be kept:

Kᵥ,·Iₚ′·R<f_{ref}, (9)

where Kᵥ is the VCO gain, Iₚ′ is the effective charge pump current, R is the loop filter resistor, and f_{ref} is the input reference frequency. At the low supply voltages used in current sub-micron technologies, Kᵥ must be large enough to guarantee lock in varying process and temperature conditions, and R must be sufficiently large to avoid jitter peaking. Therefore, from (9), Iₚ′ has its upper limit, and to guarantee the phase margin of a PLL, Iₚ′ cannot be reduced indefinitely, thus giving its lower limit. Therefore, I_{P}′ should be controlled so that it is within the range between its upper and lower limits.

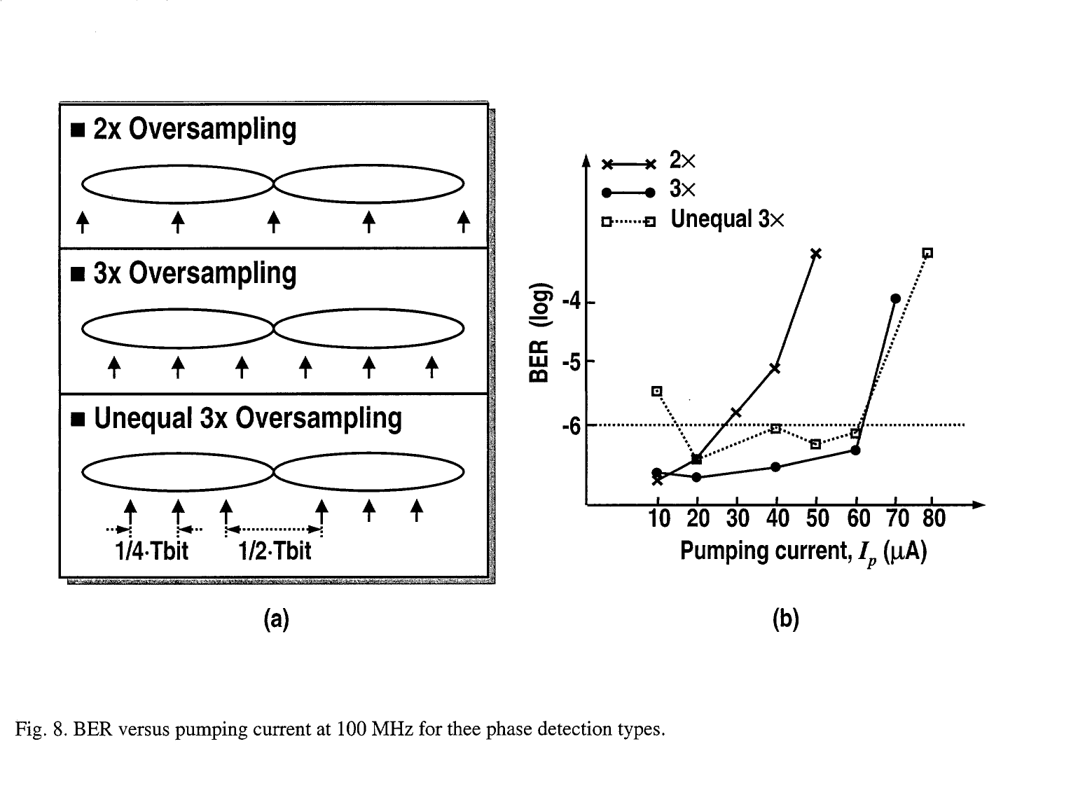

Although the effective pumping current (I_{P}′) is proportional to the actual pumping current (I_{P}), the former is also related to the jitter histogram, jitter amount, phase detection type, etc. Thus, to select the optimal phase detection type that allows a wider actual pumping-current range, simulation was performed to find the relationship of the actual pumping current versus the BER as shown in FIG. 8. The wide pumping-current range means easier PLL design in terms of loop stability. The jitter amount in this simulation is a little larger than a receiver specification and it is assumed that f_{ref} is 100 MHz, Kᵥ is 200 MHz/V, R is 1 kΩ, and the loop filter capacitance C is 350 pF. 2×, equally spaced 3×, and unequal 3× oversampling are chosen for the comparison. The 2× oversampling has a narrow pumping-current range. On the other hand, the 3× oversampling has a wider pumping-current range without BER degradation, since the dead zone between the boundary sampling clocks avoids excessive phase adjustment. A dead-zone of one-half the bit time was chosen in the unequal 3× oversampling scheme. However, this scheme does not show an improvement over the equally spaced 3×oversampling in spite of the extra complexity. Furthermore, the BER increases at low pumping current since the boundary clocks cannot prevent jitter from destroying the middle samples due to the insufficient phase margin and narrow boundary-to-middle clock spacing.

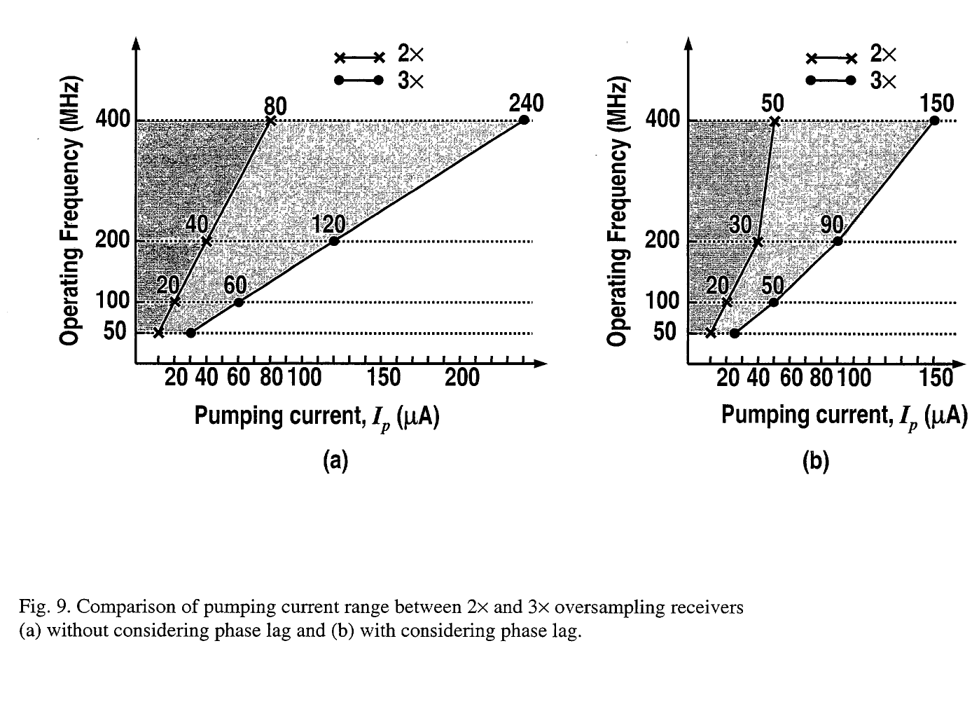

The simulation shows that the pumping-current range increases with the operating frequency, as shown in FIG. 9. This agrees with (9). Considering a 2-ns phase lag between phase detection and adjustment, the actual pumping-current range will be narrower, as shown in FIG. 9(b). However, this simulation is performed under the following three assumptions:

1) there are no process, voltage, and temperature (PVT) variations of the PLL components (except for the pumping current),

2) Kᵥ remains fixed at 200 MHz/V although the tuning range should increase with the operating frequency, and

3) there are no parasitic currents due to coupling, charge sharing, etc., to damage the PLL's operation, especially when the pumping-current is low. Therefore, in most practical cases, the pumping-current range will be reduced much more than shown in FIG. 9(b).

Thus, when 2× oversampling is used, the pumping current must be adjusted towards the optimal value depending on the operating conditions and frequency. However, the receiver with dead-zone phase detection has approximately a three times wider pumping-current range compared with 2× oversampling in the whole operating frequency range. Therefore, it operates in a wide frequency range without resorting to such a tight pumping-current adjustment. The previous tracked 3× oversampling phase detector raises several design problems due to the long pumping pulses that persist for one full VCO cycle time. The proposed design reduces the pulse width to one bit time, thereby not only avoiding the use of an extremely small pumping current, but also preventing the enlargement of the phase lag. Furthermore, since the design has no frequency-acquisition aid, its operating range is severely limited.

C. Large Jitter Tolerance of Dead-Zone Phase Detection

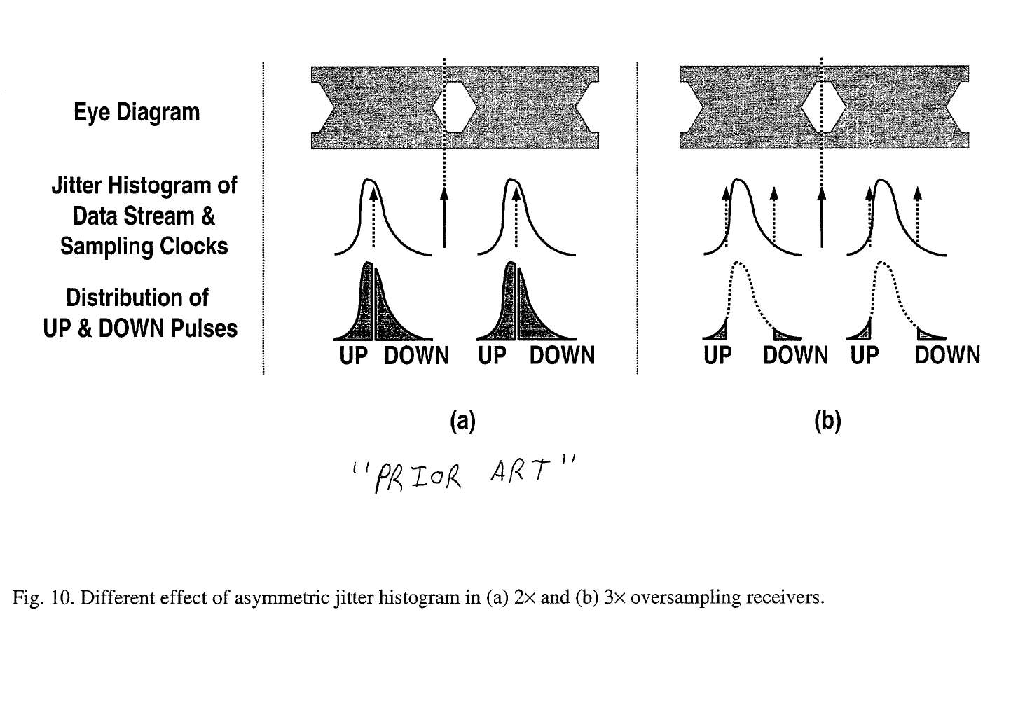

Due to systematic variation of bit times and other factors, the jitter histogram is often found to be asymmetric with a longer tail in one direction, as shown in FIG. 10. In the tracked 2× oversampling receiver, since the boundary clock edge tends to be settled at the centroid of the jitter histogram, the middle clock edge could be off the optimum point as shown in FIG. 10(a). However, in the tracked 3× oversampling receiver, since the middle clock edge is driven toward the center of an eye using only the tail portions, the middle clock edge does not vary so much in spite of the centroid shifting as shown in FIG. 10(b). Therefore, when compared with a 2× oversampling scheme, its operation is more robust in the presence of excessive jitter and bit errors are less likely to occur. Although the width of the dead zone can be varied, simulation shows the dead-zone of one-third the bit time offers adequate performance as well as simpler implementation. Interestingly, when the incoming data signal is clean with an ideal eye diagram and there is neither deterministic nor random jitter, the recovered clock drifts by up to one-third of the bit time, i.e., between +⅙×UI and −⅙×UI, thereby having more accumulated jitter. However, both the cycle-to-cycle jitter (<1/30×UI) and the BER (<10⁻¹³) are still very low.

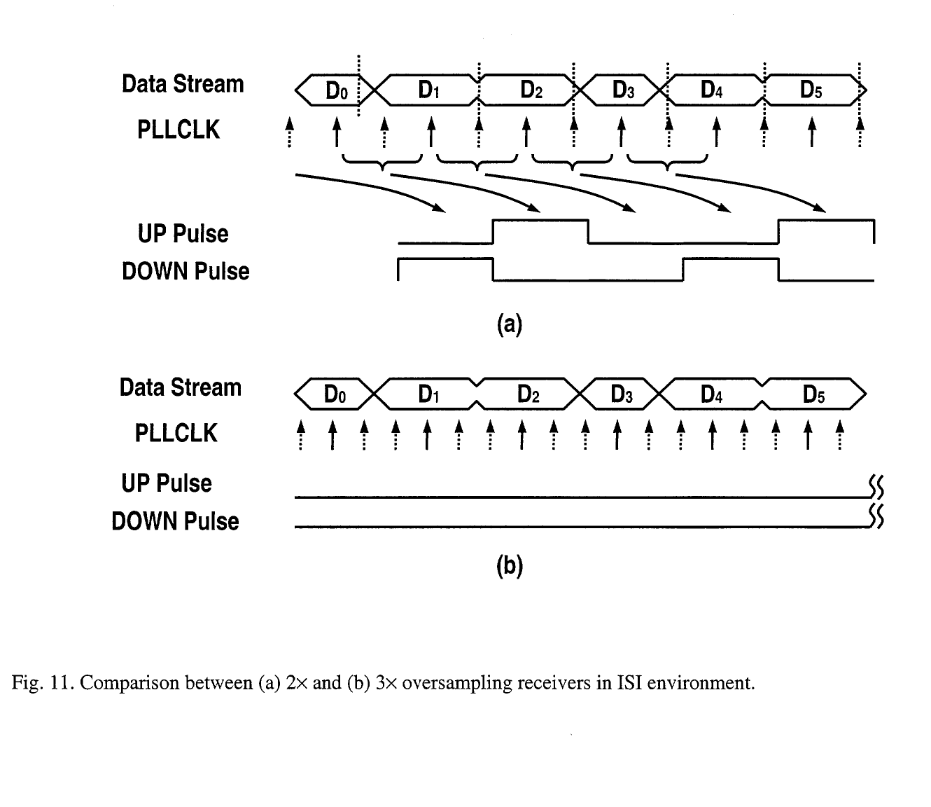

In most practical cases, such as an ISI or a periodic jitter environment, some data have a large eye width and others have a small eye width, as shown in FIG. 11. When the dead-zone phase detection is used, there is only a small number of UP and DOWN pulses. However, in 2× oversampling, UP and DOWN signals pulse alternately with alternating big and small eyes. It induces a high-frequency ripple in the control voltage even in the locked state.

D. Small Phase Error of Dead-Zone Phase Detection

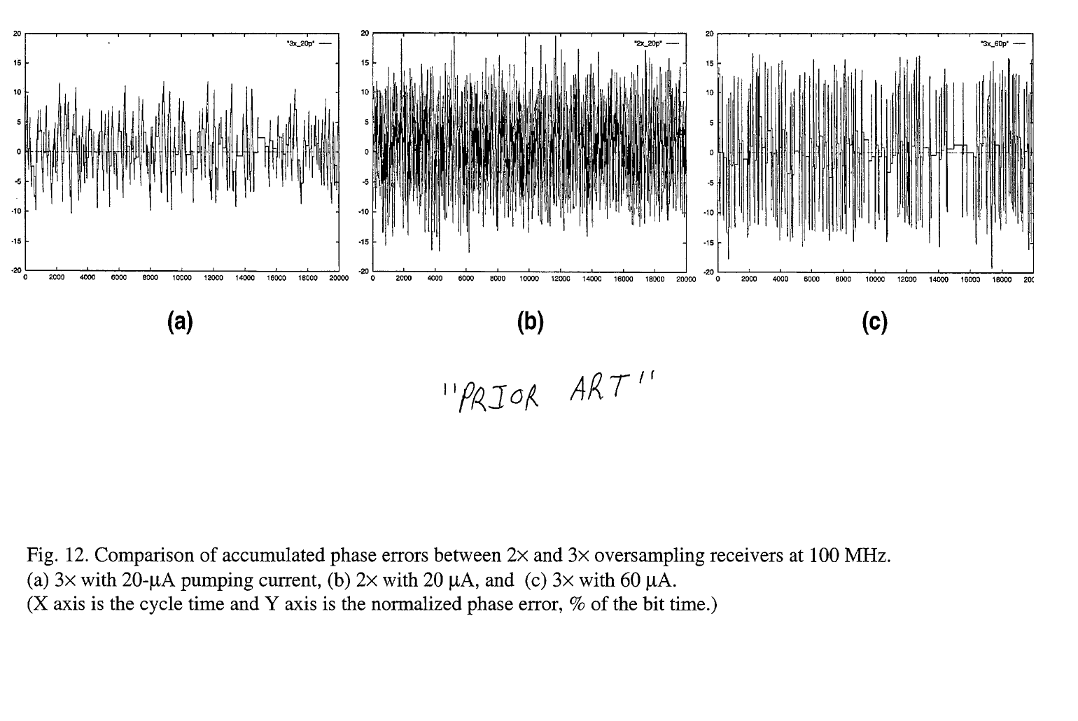

With small phase error, the middle clock edge comes close to the center of an eye, thereby lowering the BER. In 2× or (equally spaced) 3× oversampling CDR, the simulation results show that the phase error increases with the pumping current. Thus, at the lower limit of the pumping current, the receiver has the minimum phase error. The lower limit is primarily determined by parasitic currents rather than the lack of phase margin and it is around 10-20 μA. With a 10-μA pumping current, the 3× oversampling scheme exhibits 75% the phase error of the 2× scheme. With 20 μA, the former exhibits 60% the phase error of the latter as shown in FIG. 12(a) and (b). In the whole pumping-current range, if the same pumping current is used, the 3× oversampling scheme exhibits smaller phase error than the 2× scheme, and the 3× oversampling scheme with three times the pumping current induces a similar phase error to the 2× scheme as shown in FIG. 12(b) and (c).

E. Frequency Comparator

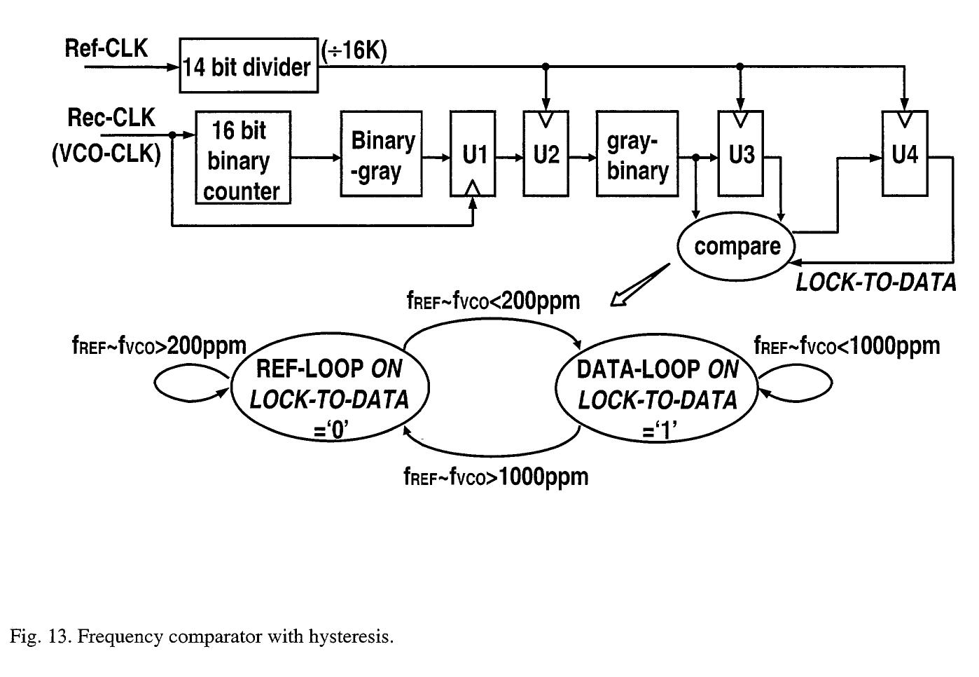

As described above, the frequency comparator has hysteresis between the lock and unlock conditions. A 16-bit binary counter is updated at every VCO-CLK cycle as shown in FIG. 13. A 14-bit divider divides the Ref-CLK. Latches, U2, sample the binary counter value at the divided Ref-CLK rising edges. However, the Ref-CLK and VCO-CLK domains are asynchronous with each other. Thus, there is the possibility that the latches fall in meta-stability when transmitted value changes on the sampling edge of the Ref-CLK. Since some bits have been already changed, but other bits have not been changed yet at the sampling time, the sampled value may be quite different from the original value. To prevent this meta-stability problem, a binary-to-gray code converter is inserted before the latching stage to allow only one bit to be inverted whenever the counter value is updated, and even if the meta-stability occurs, it does not create any problem since only a one-bit difference is induced.

After another 16,384 cycles, the latches sample the counter value once more and compare it with the previous sample for frequency comparison. If the Ref-CLK and VCO-CLK frequencies are within 200 ppm, DATA-LOOP is activated. Sometimes, a temporary frequency-mismatch may intermittently unlock the loop. Therefore, the comparator is designed to have a looser unlock condition of 1000 ppm. Since this frequency comparator does not use a reset signal, no extra cycle time for a reset procedure is required.

F. Voltage-Controlled Oscillator Based on a Folded Starved Inverter

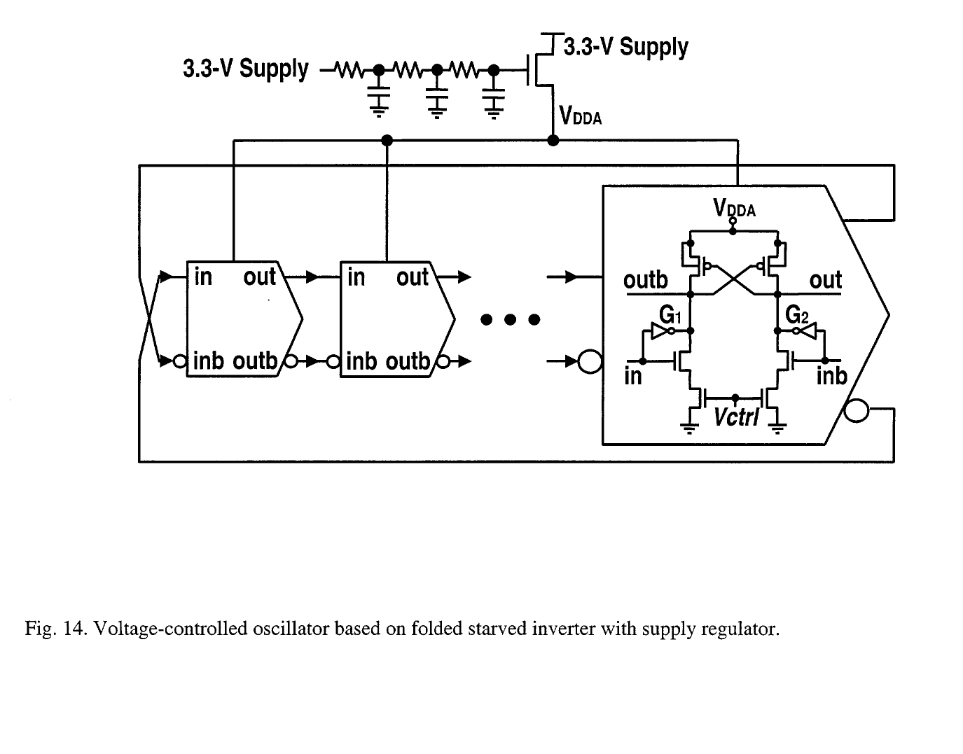

For better jitter performance, the PLL should have a structure immune to supply noise and should also contain fewer noise sources. In conventional VCOs using a replica bias circuit, most jitter is produced by noise in the bias voltage from the replica circuit. Some analyses [19], [20] indicate that the output waveform of a delay cell should be symmetric, have a fast slew rate and a large voltage swing, so a folded starved inverter has been designed with such guidelines in mind, as shown in FIG. 14. A cross-coupled PMOS pair is included to sharpen the transition edges of the output waveform regardless of the delay time. The inverters, G₁ and G₂, give more linearity to the VCO gain, and its positive supply-sensitivity compensates for the negative supply-sensitivity of the starved inverters. To further reduce the effect of power supply fluctuation, a supply regulator is added with resistors and capacitors to filter out the high frequency components of the 3.3-V I/O supply and to provide a clean voltage to the gate of an NMOS source follower. Simulation results show that the proposed VCO has about a 10-fold smaller supply sensitivity (0.23 ps/mV) and substrate sensitivity (0.26 ps/mV) than a conventional VCO using a replica bias circuit. Since there are no replica bias circuits and no tall current, this VCO has less phase noise than the replica biased VCO. Phase noise of −85 dBc/Hz at 100-kHz offset is obtained from noise simulation, which is 15 dB less than that of the VCO with replica bias.

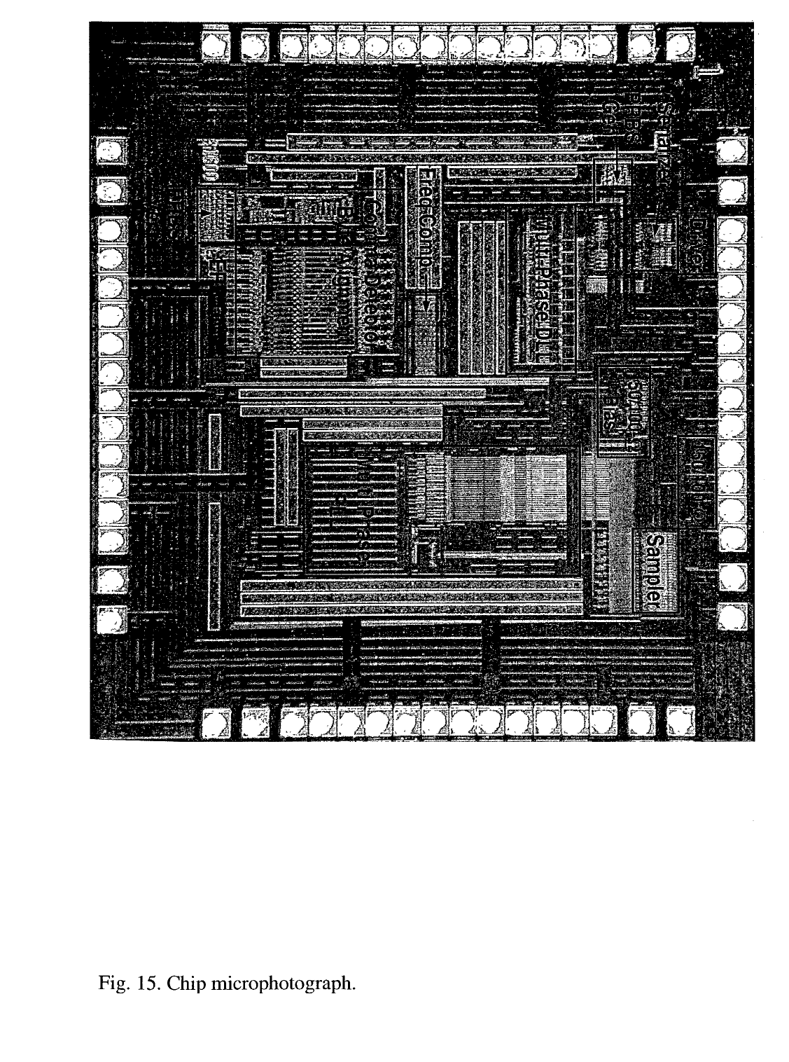

The prototype chip has been fabricated with a 0.25-μm 1-poly 4-metal logic CMOS process. The chip uses two supply voltages, 2.5V and 3.3V. The 3.3-V supply is used in the I/O circuits and the VCO in the PLL. For the other core circuits the 2.5-V supply is used. The DLL has one-quarter the size of the PLL. The designed chip is packaged with a 64-pin PQFP. FIG. 15 shows a microphotograph of the fabricated chip. The chip size is 2.3 min×2.14 min and thus is 4.9 mm².

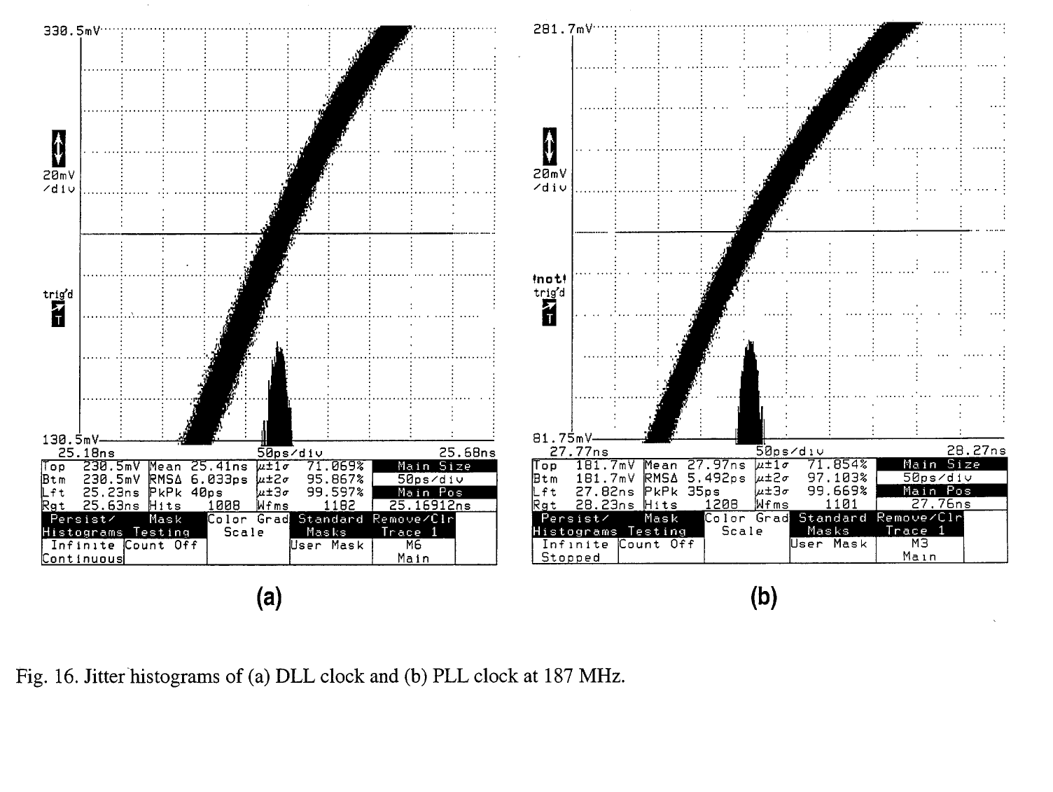

FIG. 16(a) and (b) show the measured jitter histograms of the DLL and PLL clocks, respectively, when they are locked to the reference clock at 187 MHz. The jitter performance at 187 MHz is 6-ps RMS and 40-ps peak-to-peak in the DLL, and 5.5 ps and 35 ps in the PLL. The jitter performance at 70 MHz is 3.5 ps and 21 ps in the DLL, and 3.6 ps and 25 ps in the PLL. The lower jitter at 70 MHz is due to reduced jitter of the clock source at this frequency in the measurement. Although the proposed DLL has a larger VCDL gain than the previous DLL in [6], it shows a comparable jitter performance due to pumping-current reduction and filter-capacitance enlargement. The jitter of the PLL is reduced to be half that of a replica biased PLL, which is previously designed, but not published.

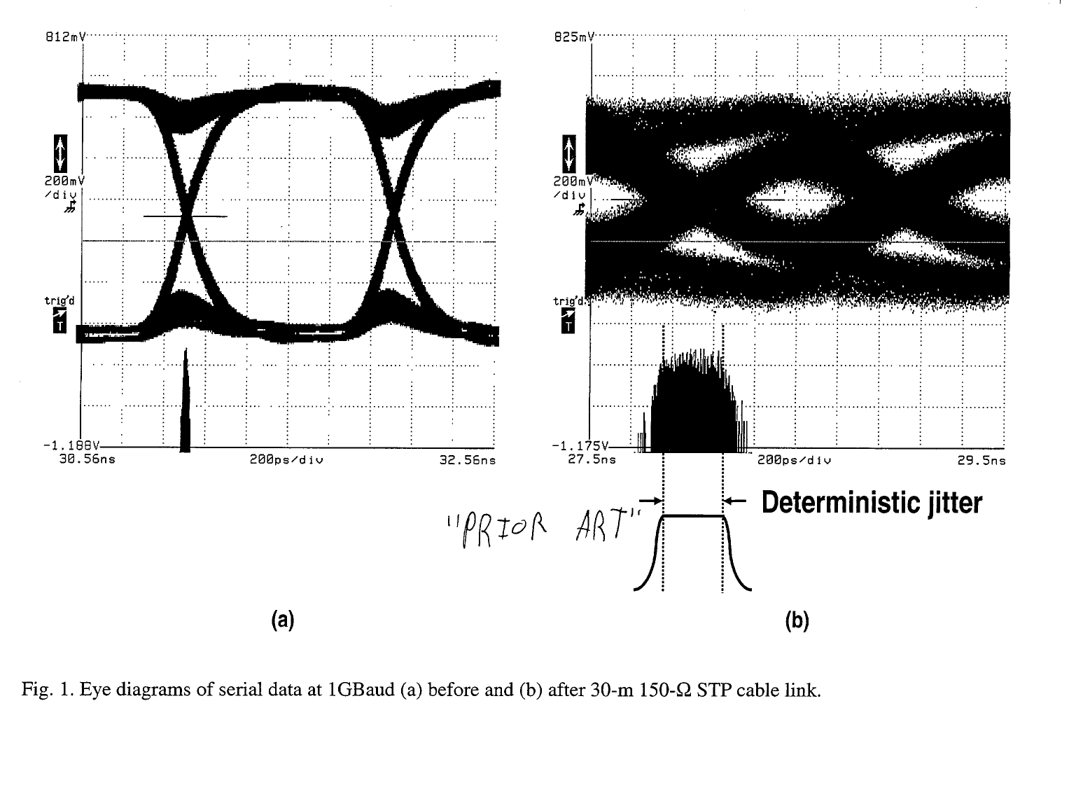

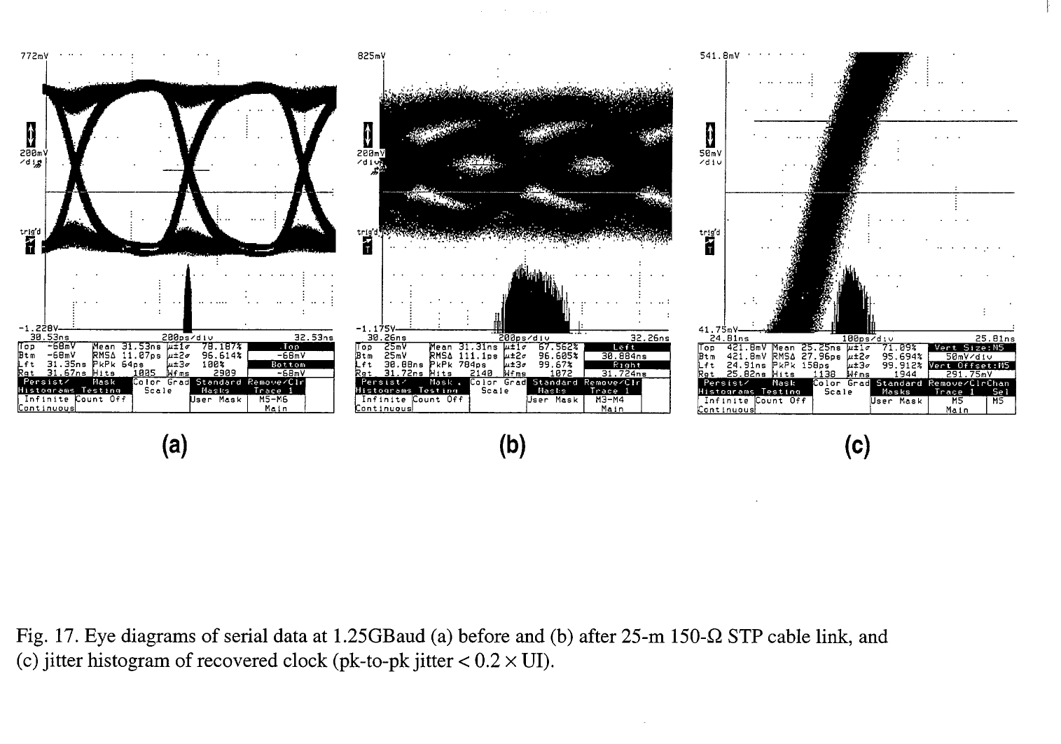

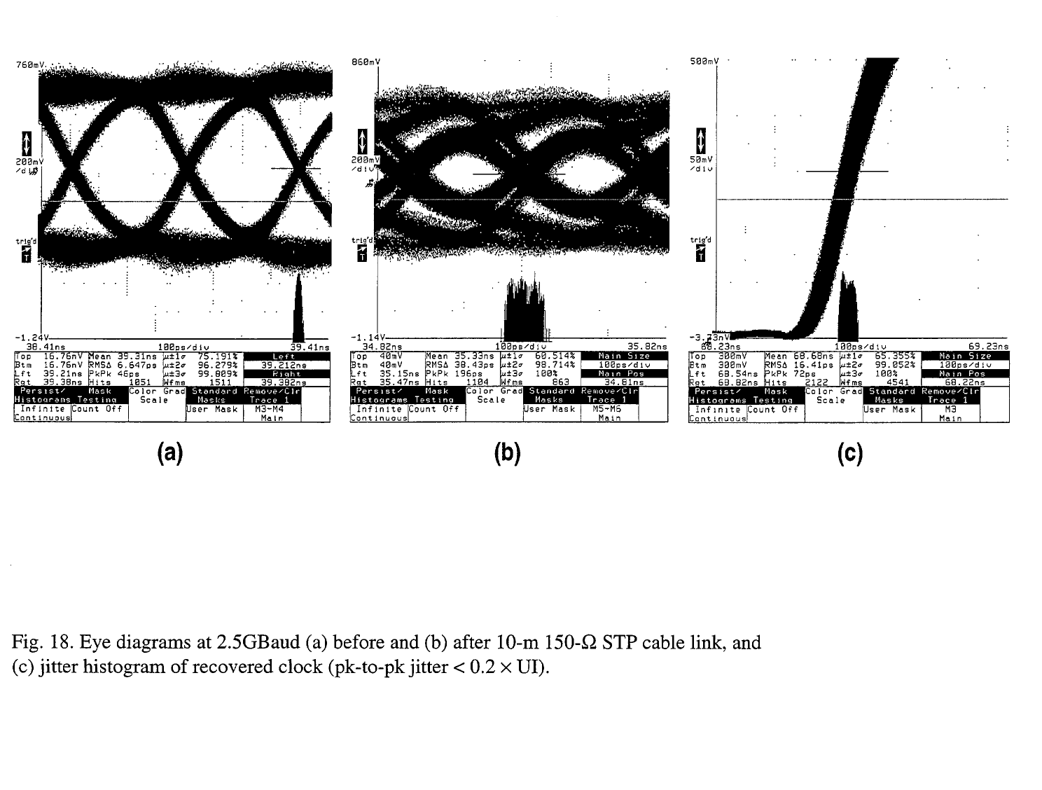

In a board-level test of the transceiver operating at 1 GBaud over a 30-m 150-i shielded twisted pair (STP) cable, at 1.25 GBaud over 25 m, and at 2.5 GBaud over 10 m, no error was detected for more than three hours, and thus the BER is less than 10-13 (see FIG. 1, FIG. 17, and FIG. 18). FIG. 1(a), FIG. 17(a), and FIG. 18(a) show that the TX data eyes have good uniformity, with less than 2% timing error among the clock phases over the range of 30 to 250 MHz, which implies that the multiphase clocks of the DLL are acceptably equally spaced. The jitter of the TX data is about 20% larger than that of the DLL clock output. Due to the dead-zone phase detection, the recovered clock jitter is actually reduced in spite of the large jitter in the incoming data signals. In the extreme case when the signal jitter is 111-ps RMS at 1.25 GBaud as shown in FIG. 17(b), the recovered clock jitter is reduced to 28-ps RMS as shown in FIG. 17(c), and the peak-to-peak jitter of the recovered clock is less than one-fifth the bit time, i.e., 0.2×UI. This measured result agrees with the simulation result in FIG. 12(a). This peak-to-peak jitter is less than the static phase error of a digital PLL-based 3× oversampling receiver. Furthermore, it is less than the static phase error of a digital PLL-based 5× oversampling receiver. Conversely, when there is little jitter in the incoming data signal, relatively large jitter is observed in the recovered clock. If, for example, a 1.25-GBaud 10-m optic fiber link is set up, the RX data are almost clean. Then, the recovered clock jitter is about 0.3×UI. However, as mentioned above, the cycle-to-cycle jitter (<1/30×UI) is still very low. Even in the optic fiber link, the transceiver operates with no error detected for more than three hours.

Table 1 summarizes the measured performance of the transceiver. The DLL frequency range is from 30 to 250 MHz. The data rate range of the link is from 0.6 to 2.5 GBaud. The power dissipation is proportional to the data rate., At 2.5 GBaud, the prototype chip consumes 269 mW.

A tracked 3× oversampling receiver with dead-zone phase detection offers wide pumping-current range, large jitter tolerance, and small phase error in the presence of excessive jitter and ISI. A wide-range multiphase DLL for a transmitter shows the maximum-to-minimum operating frequency ratio of 8.3, with a coarse phase detection to fine phase detection hand-over scheme. The multiphase clocks of the DLL are equally spaced, thereby enabling the TX data eyes to have good uniformity. A supply-regulated, folded starved inverter cell, which is designed for the low-jitter performance of the receiver VCO, offers full swing, sharp transition edge, linear gain, and low supply sensitivity. A frequency comparator with hysteresis is incorporated as a frequency acquisition aid for the receiver PLL. The transceiver, implemented in 0.25 μm CMOS technology, operates at 2.5 GBaud over a 10-m 150-Ω STP cable and at 1.25 GBaud over 25 in with a BER of less than 10⁻¹³.

In view of the foregoing, it will be appreciated that an apparatus includes means for generating a data sampling clock signal and means for using the data sampling clock signal to sample a data signal into sampled data representing a first zone, a second zone, and a third zone of the data signal. Means are used for determining which zone of the sampled data has a transition of the data signal. Means are also used for indicating a direction of change for the data sampling clock signal if the first zone or the third zone has the transition.

It will also be appreciated that a folded starved inverter differential output apparatus for use in a voltage controlled oscillator includes a first polarity of two transistors cross-coupled and a second polarity of four transistors. Also included are two inverter gates and a supply regulator.

Furthermore, a frequency comparator apparatus used with a reference clock, a voltage controlled oscillator circuit and a phase locked loop circuit includes a reference loop circuit; wherein the reference loop circuit is activated when the frequency difference between the reference clock and the voltage controlled oscillator circuit is greater than 1000 parts per million. Also included is a data loop circuit; wherein the data loop circuit is activated when the frequency difference between the reference clock and the voltage controlled oscillator circuit is less than 200 parts per million.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. An apparatus comprising means for generating a data sampling clock signal;
means for using the data sampling clock signal to sample a data signal into sampled data representing a first zone, a second zone, and a third zone of the data signal;
means for determining which zone of the sampled data has a transition of the data signal; and
means for indicating a direction of change for the data sampling clock signal if the first zone or the third zone has the transition.

2. A folded starved inverter differential output apparatus for use in a voltage controlled oscillator comprising:
a first polarity of two transistors cross-coupled;
a second polarity of four transistors;
two inverter gates; and
a supply regulator.

3. A frequency comparator apparatus used with a reference clock, a voltage controlled oscillator circuit and a phase locked loop circuit comprising:
a reference loop circuit; wherein the reference loop circuit is activated when the frequency difference between the reference clock and the voltage controlled oscillator circuit is greater than 1000 parts per million; and
a data loop circuit; wherein the data loop circuit is activated when the frequency difference between the reference clock and the voltage controlled oscillator circuit is less than 200 parts per million.
